(19) United States
(12) Patent Application Publication
(10) Pub. No.: US 2024/0330859 A1
(43) Pub. Date: Oct. 3, 2024

(54) System and Method for Managing Groups Formed by Organizations

(71) Applicant: Elixsys, Inc., San Diego, CA (US)

(72) Inventor: Himabindu Gaddipati, San Diego, CA (US)

(21) Appl. No.: 18/192,890

(22) Filed: Mar. 30, 2023

(51) Int. Cl. G06Q 10/101; G06Q 10/0631; G06Q 10/10

(52) U.S. Cl. CPC G06Q 10/101; G06Q 10/063114; G06Q 10/063118; G06Q 10/06312; G06Q 10/103

(57) ABSTRACT

Various embodiments of a method and apparatus for organizing groups formed by independent organizations are disclosed. The system includes a database and a user interface for managing a group. The user interface includes a visual indication of a group, which includes visual indications of organizations that are part of the group. The organizations include organizations that are independent of one another. The user interface includes tools for managing the group by a group administrator. The group administrator is associated with one of the organizations, which facilitates collaboration between the organizations.

### BACKGROUND

### (1) Technical Field

The disclosed method and apparatus relate generally to information management systems. In particular, the disclosed method and apparatus relate to storing, retrieving, organizing and displaying information related to organizations.

### (2) Background

It is sometimes desirable for organizations to collaborate. When organizations collaborate, members of the organizations interact with one another in complicated ways. It is often desirable to track the ways members of an organization interact with one another, the relationship of members of an organization to the organization to which they belong, and the relationship of members of one organization to other related organizations, as well as the relationships between members of various related organizations. Managing information about individuals from different organizations and tracking the relationships of the members of such organizations in the context of associated organizational hierarchical relationships is daunting.

Accordingly, it would be advantageous to provide a system that can receive, store, organize, establish workable relationships, manage and display information about organizations and the members of such organizations and their interactions in a way that allows the system user to gain an advantage from tracking the interactions and relationships of such organizations and the members of those organizations.

### SUMMARY

Various embodiments of a method and apparatus for receiving, storing, organizing, establishing workable relationships, managing and displaying information regarding organizations and their members are disclosed.

In some embodiments, the organizations have an independent internal hierarchical structure, as well as being placed within a group having a hierarchical structure with respect to other organizations placed within the same group. In other embodiments, either the organization or the group have a “nested” structure. A processor, graphical user interface and memory facilitate creating groups, receiving, storing, organizing, and establishing working relationships for information regarding the organizations and displaying information regarding the groups and the organizations within the groups, including the working relationships established between members of organizations, different organizations and various groups of organizations. In some embodiments, groups or organizations are formed based on one or more purposes and/or goals for the group. The processor, graphical user interface and memory also facilitate managing ongoing tasks (e.g., assigning users to the tasks and tracking the progress of the tasks).

The system implements a method for managing groups in which a user (i.e., a group administrator or other participant in the group) selects or searches for a group. In response, a group dashboard is displayed, which includes a dashboard providing links to the rest of the user interface for managing groups and for users to access the groups to which they belong. Depending on the user's selection, one or more modules of a processor are activated.

When one of the modules of the processor is activated, a group diagram is presented to the user or group administrator. In another module, a list of subgroups is displayed. In another module, a search box is displayed for finding other groups and subgroups. In another module, a page is displayed for comparing organizations that are part of the group. In another module, a tool is provided for filtering which organizations that are part of the group are displayed. In some embodiments, a list of predefined filters is displayed in a side panel, which in some embodiments are displayed as hexagons. In one module, tools for an executive management suite are displayed. If the tools for managing the executive management suites are displayed, then the user is given options for creating or altering a mission statement, initiatives, committee roles, meeting minutes, milestones, tasks, attachments, reports, shared links, group users and a message board.

In some embodiments, a database for implementing the method includes a post attachment table, post table, a network request table, a network user table, a group table, an answer table, a user table, an organization division table, an organization table, an invite user table, a category table, a group entity table and entity tables.

In some embodiments, a dashboard is provided for accessing a group view link, a map view link, a bubble view link and a my-network link.

In some embodiments, the stakeholder's wheel includes a central hexagon with a list of organizations associated with the group, which in some embodiments are also displayed as hexagons. In some embodiments, a list of subgroups is displayed, which in some embodiments includes a display of hexagons representing the subgroups. Selecting one of the hexagons displays a dashboard for the subgroup. In some embodiments, when the page for managing groups is initially opened, no icons are present. However, a field appears for entering a group name. In some embodiments, after entering the group name, an executive management link and the stakeholder wheel appear.

In some embodiments, a page for creating and editing a group is provided. Creating the group includes determining whether the group will be private. Setting a name for the group name, a description of the group, setting contact information for the group, associating a calendar with the group and determining the group administrators.

In some embodiments, a page is provided for requesting entry into a group or subgroup and for managing requests to enter a group. In some embodiments, a page is provided for a user to view a list of the groups in which the user participates. In some embodiments, a page is provided for viewing the status of group requests (requests by organizations to join a group). In some embodiments, a page is provided with tabs linking to different pages for adding or editing information about a group, such as the mission statement, initiative, meeting minutes, committee roles, tasks and attachments. In some embodiments, the tasks can include subtasks, and the priority and status of the tasks and subtasks are visually indicated.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates a diagram of an embodiment of a method for managing cooperative groups formed by organizations.

FIG. 2 illustrates an entity relationship diagram of an embodiment of a database used by the method of FIG. 1 for managing groups formed between organizations.

FIG. 3 illustrates a diagram of a system in which the method of FIG. 1 is implemented.

FIG. 4 illustrates a screenshot of an embodiment of a homepage of a system for managing groups.

FIG. 5 illustrates a screenshot of an embodiment of a page for managing groups.

FIG. 6 illustrates a screenshot of an embodiment of a page for creating and editing a group.

FIG. 7 illustrates a screenshot of an embodiment of a page for requesting entry to a group.

FIG. 8 illustrates a screenshot of an embodiment of a page for managing group requests.

FIG. 9 illustrates a screenshot of an embodiment of a page for viewing, removing and updating action items.

FIG. 10 illustrates a screenshot of another embodiment or another aspect of the page FIG. 9.

FIG. 11 illustrates a screenshot of an embodiment of an attachment page that lists shared documents.

FIG. 12 illustrates a screenshot of an embodiment of a group users page having an invite user page.

FIG. 13 illustrates a screenshot of an embodiment of a group integration page for viewing and interacting with a list of third-party applications that have been integrated into the group.

FIG. 14 illustrates a page of an embodiment of a recent items page.

The figures are not intended to be exhaustive or to limit the claimed invention to the precise form disclosed. It should be understood that the disclosed method and apparatus can be practiced with modification or alteration, and that the invention should be limited only by the claims and the equivalents thereof.

### DETAILED DESCRIPTION

In some embodiments, a system is provided for receiving, storing, organizing, managing and displaying information regarding organizations and their members and establishing workable relationships between the information that has been organized. In some embodiments, organizations are associated with one another in groups. In some embodiments, the organizations within a group are of equal hierarchical status with respect to one another. In some such embodiments, the organizations may be “nested” to reduce the amount of information displayed at once. In some such embodiments, the organizations may be nested in an essentially arbitrary manner. Alternatively, the groups are hierarchical structures.

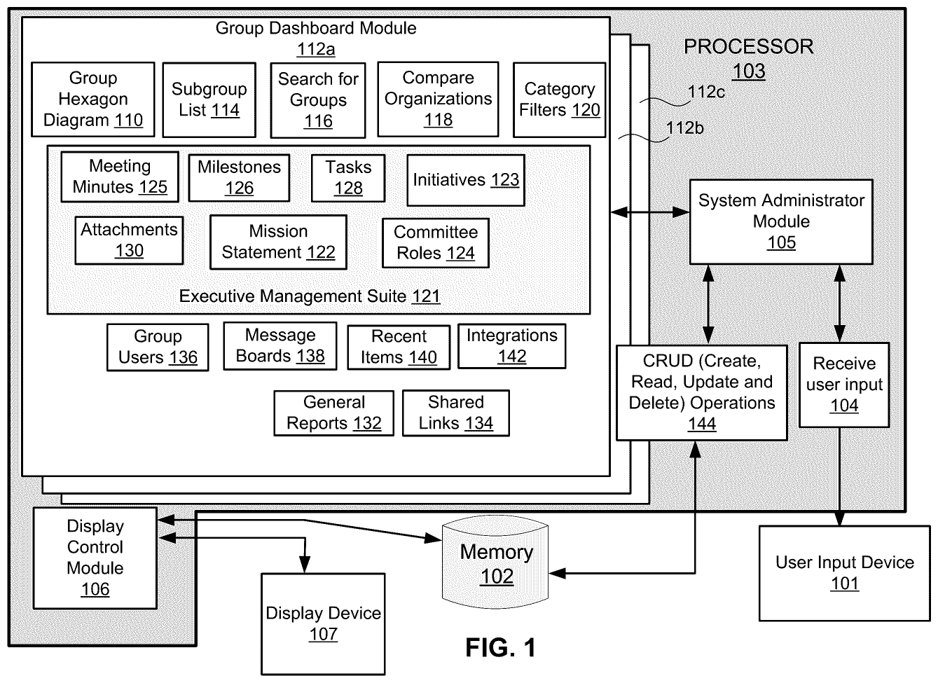

FIG. 1 illustrates a schematic diagram of selected modules of an apparatus presently disclosed. A user input device 101 and a memory device 102 are coupled to a processor 103. A User Input Receiving Module 104 residing within the processor 103 receives user input from the user input device 101. In some embodiments the user input device 101 is: (1) a keyboard, (2) touchscreen, (3) communication module coupled to a wireless communication link, or (4) any other means for user input data to be provided to the other modules within processor 103. In some embodiments, upon initialization, a SAM (System Administration Module) 105 communicates with a DCM (Display Control Module) 106 to cause a homepage to be displayed on a display device 107.

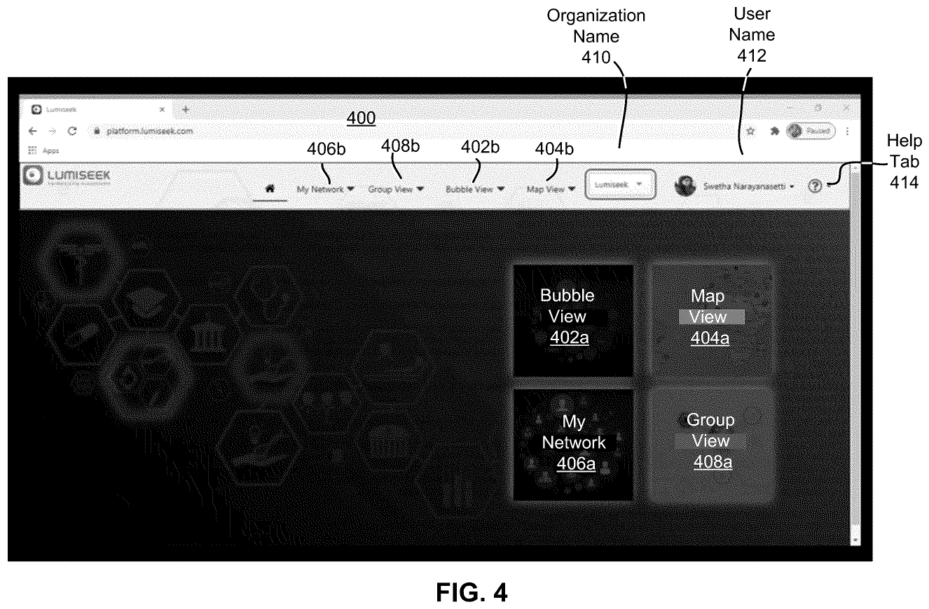

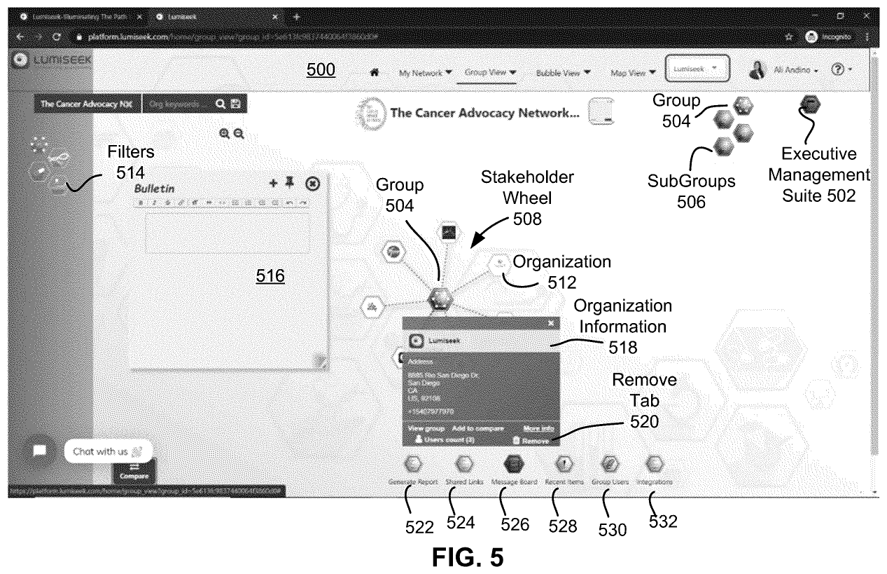

FIG. 4 is an illustration of a homepage in accordance with one embodiment of the disclosed method and apparatus. In some such embodiments, the homepage 400 provides access to a plurality of icons 402a, 404a, 406a, 408a and tabs 402b, 404b, 406b, 408b to allow the user to activate various modules in the processor 103. For example, when a user uses the user input device to activate a bubble view icon 402a, such as by pressing on the icon 402a in the case in which the icon 402a is being displayed on a touchscreen, the user input device 101 provides an input to the User Input Receiving Module 104. The User Input Receiving Module 104 in turn provides an indication to the SAM 105 from which the SAM 105 can determine that the user has activated the bubble view icon 402a. The SAM 105 then activates a GHDM (Group Hexagon Diagram Module) 110 associated with the group represented by the icon 402a that the user activated. A group link 504 (see FIG. 5) is displayed as a central hexagon with organizations in the group are displayed around the central hexagon in relatively close proximity. The manner in which the organizations are displayed makes clear that the organizations are part of the group. In some embodiments, the organizations that are part of the group are also displayed as hexagons 512 (see FIG. 5). In addition, the SAM 105 activates a Subgroup Module 114 which provides information regarding subgroups that reside within the group. A subgroup is a set of organizations that are grouped together. Such nesting of organizations in groups having subgroups which might in turn have subgroups allows very large numbers of organizations to be handled efficiently in a manner that a user can more easily understand and grasp. In some embodiments, organizations are placed within a subgroup based on one or more characteristics that are common among the organizations. In some such embodiments, the groups and subgroups are arranged in a hierarchy. However, the characteristics that are used to place an organization within a group or subgroup may not reside within a hierarchical structure. In other embodiments, selection of which organizations and/or subgroups is arbitrary (i.e., the placement is not based on a particular characteristic that is common to the organizations and/or subgroups).

In response, the display control module displays a list of subgroups that are associated with the group represented by the group link 504. The subgroups are associated with the group, which in some embodiments includes hexagons 506 (see FIG. 5) representing the subgroups. In some embodiments, selecting one of the hexagons representing a subgroup activates a GDM 112 for the subgroup, causing a graphic (e.g., a hexagon) associated with the subgroup to be displayed. In some such embodiments, there is one GDM 112 for each of the group links, whether the group link represents a group or subgroup.

Alternatively, the user can activate the map view icon 404a, the my-network icon 406a or the group view icon 408a, each of which are squares which taken together with the bubble view icon 402a are arranged in a block. In the embodiment of FIG. 4, the tabs displayed for the bubble view 402b, the map view 404b, the my-network 406b and the group view 408b on the upper pane of a viewing window provide alternative means for the user to activate the associated modules within the processor 103.

The bubble view controls 402a, 402b activate modules in the processor 103 that display a view that represents a set of entities as a group as bubbles having information about the entities. The map view 404a and 404b are links to a view that represents the entities in a group on a map indicating the location of each entity, the group to which the entity belongs, and other information about the entity. The my-network 406a and 406b are links to a view illustrating the users that the current user befriended. The group views 408a and 408b provide links to a view in which groups are represented as a star having an icon representing the group in the center, with spokes radiating out to different stakeholders (organizations or members) of the group, which may be referred to as a stakeholder wheel. The view presented by the group view 408a and 408b can be used to manage a group. The organization name 410 and the user name 412 provide the name of the organization associated with account, via which homepage 400 is being accessed. The homepage 400 also includes an organization name 410, a user name 412 and a help link 414. The help link 414, when selected provides a tutorial about using the site.

When the user input receiving module receives a Display Homepage Command from the user input device 101, a homepage is displayed in response to the received command. In some embodiments, the User Input Receiving Module 104 is configured to receive user input that includes information designating a group. The designated group comprises a list of organizations. In response to receiving such user input, the processor activates a SAM (System Administration Module) 105. Upon being activated, the SAM 105 performs a search through the memory device 102 for information related to the group designated by the user in the user input. In some embodiments, as in the embodiment shown, interactions between the SAM 105 and the memory device 102 are managed by a CRUD (Create, Read, Update and Delete) Module 144. Accordingly, the SAM 105 communicates with the DCM 106 through the CRUD Module 144. In some embodiments, the User Input Receiving Module 104 is further configured (or alternatively configured) to receive user input that includes a user command requesting that a list of groups be displayed. In response to the user input, the User Input Receiving Module 104 requests the SAM 105 to retrieve a list of groups from the memory device 102 and to display the list. Once displayed, the user can select a group from the displayed list of groups.

When the GHDM 110 is activated, a group dashboard for the group selected is displayed. In some embodiments, the group dashboard includes a group name, a bulletin board and information about the group.

A Search for Groups Module 116 is activated by the user placing information in a search box displayed for finding other groups and subgroups. A Compare Organizations Module 118 is activated for comparing organizations that are part of a group with one another. When a Category Filters Module 120 is activated, a tool is presented to the user for filtering which organizations of the group are displayed. In some embodiments, a list of predefined filters is displayed in a side panel. In some embodiments, each filter is displayed as a hexagon.

When Executive Management Suite Module 121 is activated, the user is presented with a choice of implementing any activating modules 122, 123, 124, 125, 126, 128, 130.

Mission Statement Module 122 and Initiatives Module 123 (depending on which is activated), present the user with options for viewing, creating or altering a mission statement and initiatives, respectfully, of the current group. A Committee Roles Module 124 presents the user with options for assigning and changing the committee roles of a committee of the current group to a user that participates in the group. A Meeting Minutes Module 125 and Milestones Module 126 present the user with options for creating, editing, updating, viewing and altering meeting minutes of meetings and milestones, respectively, associated with the current group. a Tasks Module 128 presents the user with options for viewing, creating, updating, editing, reading, and deleting tasks assigned to members of the current group and assigning tasks to users participating in the current group. The Attachments Module 130 within the Executive Suite Module 121 presents the user with options for creating, updating, editing, reading and deleting attachments to posts associated with the group.

The General Reports Module 132 presents the user with options for generating reports about the activities of the group. The Shared Links Module 134 presents the user with options for viewing, creating, altering and removing shared links. The shared link is a link to which multiple users of the group are provided access. The Group Users Module 136 presents an administrator with options for selecting and inviting organizations to join the group. User may also add and remove organizations from a group. In some embodiments, the Group Users Module 136 provides a list of group users (organizations) that administrator can also edit.

The Message Board Module 138 presents the user with options for viewing a message board, adding messages to a message board, removing messages from a message board and editing messages on a message board. The Recent Items Module 140 presents users with options for viewing and interacting with a list of recent items. In some embodiments, the recent items can be recent events, tasks, meeting minutes, reports, initiatives, mission statements and milestones. In some embodiments, the user can open a recent item and perform further work related to the recent item. The Integrations Module 142 presents the user with tools and options for integrating third-party applications into the group (such as Microsoft Office, Acrobat and Dropbox) granting participants in the group use of the third-party application, via the group, and removing the third-party applications from the group. In some embodiments, when the Integrations Module 142 is activated, a list is provided of third-party platforms that have been integrated into the system.

As part of and in response to modules 118-142, the SAM 105 activates the CRUD Module 144. The CRUD Module 144, operates on the tables and records stored in the memory device 101. The memory device 101 stores tables with information for managing the groups. In some embodiments, a database is implemented within the memory device and is managed by the CRUD Module 144. Alternatively, such a database is operated by an independent module within the processor 103 or external to the processor 103.

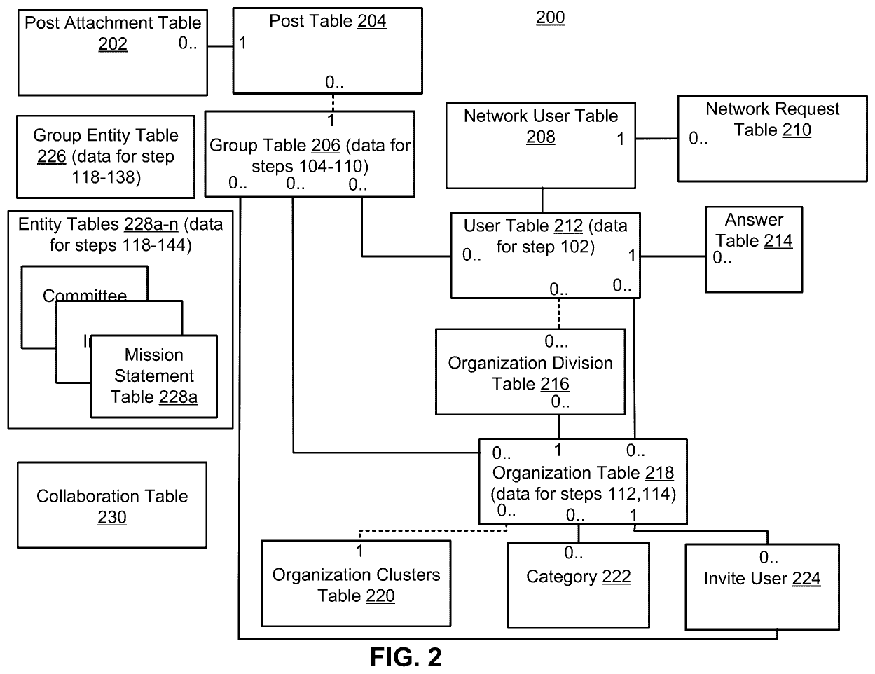

FIG. 2 illustrates an embodiment of a database implemented with the memory device 101 of FIG. 1. The database includes a post attachment table 202, a post table 204, a group table 206, a network user table 208, a network request table 210, an answer table 214, a user table 212, an organization division table 216, an organization table 218, an organization cluster table 220, a category table 222, an invite user table 224, group entity tables 226, entity tables 228a-n and collaboration table 230.

In FIG. 2, tables that are related to one another are connected by lines. Dashed lines are used to indicate an optional relationship. At each end of each line are the legends 0 . . . or 1. The legend 0 . . . indicates that there may be any number from 0 upward of that type of table in the relationship. In this specification, the 0 . . . is to be interpreted as generic to any cardinality. For example, 0 . . . is generic to an optional connection, 0,1, 1,1 and 1 . . . . The legend 1 indicates that there is one of that type of table in the relationship. For example, a line having the legend 0 . . . at a first end and 1 at a second end indicates that in the relationship indicated by the line, there are 0 or more tables of the type at the first end of the line and 1 table of the type at the second end of the line. The term “table” is used interchangeably with the term “object,” the term “attribute” is used interchangeably with the term “column” and the term “record” is used interchangeably with the term “row.” Each “object” may also be referred to as a “class.” In the following discussion, names for referring to attributes are parenthetically inserted, enclosed in quotation marks, to facilitate identifying related tables and keys/attributes that are shared by multiple tables (however, the attribute could be given a different name without affecting the functioning of the database). Attributes that are only mentioned once or not used for establishing a relationship with another table are not necessarily given a name.

The post attachment table 202 stores attachments to posts and information about the attachments. The post attachments table 202 includes attributes (columns) for the posts (“posts”), the attachments to the post (“post attachments”), the file ID of the attachment, the filename and the type of storage needed for storing the attachment.

The post table 204 stores the content of the posts and information about the posts. The post table 204 also includes attributes for identifying the posts (“posts”), storing the content of the posts, an indication of whether the post is private, values indicating how to sort the posts, and the number of times the post was viewed. In the posts table 204, the post attachments attribute is a foreign key referencing the post attachment table, which lists the attachments to posts, and the posts attribute is a primary key listing the posts of a particular group. Each post attachment table 202 is related to at least one corresponding post table 204, but any post table 204 could be related to zero or any higher number of post attachment tables 202.

The group table 206 stores information characterizing the groups and is used for managing the groups. The group table 206 stores information about the activities, goals, purposes and makeup of the group. The information in group table 206 is used for implementing the modules 106-110 of FIG. 1.

The group table 206 includes attributes for identifying groups related to the current group (“groups”), organizations associated with the group (“organization”) and posts (“posts”) associated with the group. In some embodiments, the posts attribute is a foreign key referencing the post table 204 and the organization attribute is a foreign key referencing the organization table 218. Each post table 204 is related to a corresponding group table 206, but any post group table 206 could be related to zero or any higher number of post tables 204.

The group table 206 also includes attributes for a status of the group, a calendar duration for the group, indications of whether the group is private, invisible to nonmembers or nonparticipants, group notes (e.g., meeting minutes), an indication of whether the group is a trial group, a trial period, a description of the group, an indicator of whether the group is free, a filter for the life cycle of the group, an indicator of a parent group from which the current group originated, a status filter, a sorting order value for sorting the groups with respect to other groups. In some embodiments, the group table 206 includes attributes viewing and calendaring events, tasks, and deadlines associated with the group (i.e., “calendar ID,” “calendar name,” “calendar duration” and “calendar events”).

The network user table 208 stores information about network users. The attributes of the network user table 208 include identifiers of network users (“network user”), identifiers of friends of the network users (“friend users”), notes about or by the network user, c-mail addresses of the friends (“friend emails”) of the network user and a tag of the network user (“tag”). In some embodiments, the tag of the network user is a foreign key referencing a table giving more information about the user. A network user is a user that participated in an accepted network request (e.g., a request to join a user's network). In other words, after a user sends a request, if the request is accepted, then the user that accepted the request and the user that sent the request become network users. In some embodiments, the network user that accepted the request also becomes a friend user of the user that sent the request, and in some embodiments, the network user that sent the request becomes a friend user of the network user that accepted the request.

The network request table 210 stores requests by users and information about the requests (i.e., requests from one user to another user to join the user's network). The network request table 210 includes attributes for the network request, friend users, the network user associated with the request, a status of the request (i.e., answered, unanswered, accepted or rejected), a user tag associated with the network user that is associated with the network request, a friend email (or other contact information of the friend) and a friend organization id that identifies an organization associated with the friend.

The user table 212 includes information about users of a group. The user table 212 stores information indicative of a level at which access is authorized for the user. The user table 212 provides this information to the SAM 105. The user table includes attributes of answers to questions (“answers”) submitted to or from the user. In some embodiments, the user table 212 includes attributes for network users (“network user”) related to the current user and friend users (“friend user”) of the current user. In some embodiments, the user table 212 includes attributes indicating the experience of the user, a technology in which the user is working or interested. In some embodiments, the user table includes attributes for the groups (“groups”) associated with the current user, the organization (“organization”) associated with the user, network requests (“network request”) associated with the user, emails associated with the user, identifying information of the user, contact information of the user, authentication information associated with the user, whether to disable an introductory video (or remove other introductory information) and confirmations of communications sent. In some embodiments, the group, network user, network request, answer and organization attributes of user table 212 are foreign keys related to the group table 206, the network user table 208, the network request table 210, the answer table 214 and the organization table 216, respectively.

The user table 212 and network user table 208 are related to one another by two relationships, which include the user attribute and the network user attribute. Each network user table 208 is related to a user table 212 by the network user attribute and the user attribute, but any user table 212 could be related to zero or any higher number of network user table 208. Similarly, the user table 212 is related to the network request table 210 by two relationships, the network request attribute and the friend user attribute. Every network request table 210 is related to at least one user table 212, but any user table 212 could be related to zero or any higher number of network request table 210.

The answer table 214 includes answers to questions and information about the questions. The answer table 214 includes attributes for answers (“answers”) to questions (a primary key for the answer table 214), whether the answer is searchable and an organization associated with the answer. Every answer table 214 is related to a corresponding organization table 218 and user table 212, but any user table 212 or organization table 218 could be related to zero or any higher number of answer tables 214.

The organization division table 216 includes information about the divisions of an organization. In some embodiments, the organization division table 216 includes attributes having identifying information about the “organization division”, identifying information about the organization that the organization division is associated with, the users associated with the organization division, an identifier of a user having an administrator role for the organization division, a location associated with the organization division, a name of the organization division and other information identifying the organization division. In some embodiments, the user attribute and the organization attribute of the organization division are foreign keys that reference the user table 212 and the organization table 218, respectively. The organization division table 216 is related to a corresponding user table 212 and organization table 218, but any organization table 218 could be related to zero or any higher number of organization division table 216.

The organization table 218 includes information about individual organizations, which are organizations that are on the platform and can participate in the groups. The information stored in the organization table 218 is used for implementing the modules 112 and 114. The organization table 218 includes attributes for answers (“answers”) to question associated with the organization, organization divisions (“organization divisions”) associated with the organization, information identifying of the current organization (“organization”), other organizations associated with the current organization (“organizations”) (i.e., partners, parent companies, subsidiaries, other siblings of the same parent company and other companies that are also stakeholders in a company partly owned by the organization), users (“users”) associated with the organization, group administrators associated with the organization, groups (“groups”) in which the organization participates, a status of the organization, a name of the organization, a size of the organization, locations of the organization, a size of the different locations of the organization, emails associated with the organization, e-mail domains associated with the organization and a primary category associated with the organization. In some embodiments, the group attribute, the user attribute and the organization division attribute of the organization table 214 are foreign keys referencing the group table 206, user table 212, the answer table 214 and the organization division table 216, respectively.

The organization table 218 is related to the user table 214 by two relationships, the users attribute and the organization attribute. The organization table 218 is related to the organization division table 216 by two relationships, the organization attribute and the organization division attribute. Any organization table 218 could be related to zero or any higher number of organization division table 216. However, every organization division table 216 is associated with an organization table 218 (because an organization does not necessarily have divisions, but divisions are always divisions of an organization).

The invite user table 220 includes invitations to users to join a group and information about the invitations. The invite user table 220 includes attributes of a status of the invitation, an organization (“organization”) to which the invitation was sent and a group (“group”) in which the invitation invited the user to participate. The attributes of organization and group are foreign keys referencing the organization table 218 and the group table 206, respectively. Each invite user table 220 relates to a corresponding group table 214 and organization table 218, but any group table 214 or user table 220 could be related to zero or any higher number of invite user table 220.

The category table 222 includes information about the different categories of organization. The organization cluster table 224 includes information about different objects associated with an organization. In some embodiments, at the creation of the organization, the organization is assigned a category/cluster. The attributes of the category table 222 and cluster table 224 include the attributes of organizations (“organizations”) belonging to a category/cluster, a status of the category/cluster and a name of the category/cluster. In some embodiments, the category table 222 includes a visual indication attribute, which is associated with a visual indication representing each organization. In some embodiments, the visual indicator is a shape associated with an icon representing the organization. In some embodiments, the visual indication is color, which indicates a color (or category) that is associated with the organization. In other embodiments, another visual indicator is used for representing the group. Organization and categories are represented by logos and icons respectively.

The group entity table 226 is a table of entities characterizing groups correlated with the groups associated with the entities. The entity tables 228 a-n are individual tables—each table is for a different entity, and each entity has a table, which is one of the entity tables 228 a-n. The entities of the group entities table and entities table are objects used for characterizing and managing the groups. Some examples of entities are tables for mission statements, meeting minutes, tasks, initiatives, committee roles, time lines, and events. In some embodiments, the group entity table 226 includes a foreign key for each entity, which is a primary key for the entity table that the foreign key references.

In some embodiments, a collaboration table 230 is used to aid in tracking the collaboration, which includes a message attribute, a from-user attribute, a from-organization attribute, a to-user attribute and a to-organization attribute, for storing a message correlated with the users between which the message was sent and the organizations associated with the users exchanging the message. In some embodiments, the collaboration table 230 is not related to other tables.

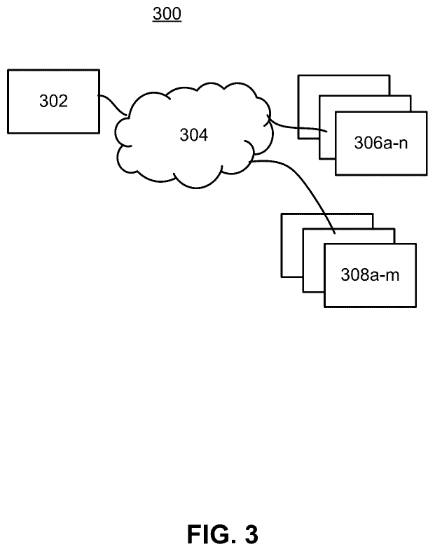

FIG. 3 illustrates an example of a system 300 that implements method 100 and stores the database of FIG. 2. The system 300 includes a group service provider 302, a network 304, organizations 306a-n, and users 308a-m. The group service provider 302 includes one or more machines that store information about groups and provide services for managing groups. The group service provider 302 communicates with the organizations 306a-n and the users 308a-m, via network 304. In some embodiments, each of the organizations 306a-n includes one or more machines, which may be located in different locations that are run by the organization. The machines of the organization 304 are operated by users on behalf of the organization. The users 308a-m include machines that are run by the users. In some embodiments, the users 308a-m are associated with one or more of the organizations 306a-n, but the machines of the users 308a-m are not run by the organization. In some embodiments, although the users 308a-m use machines not associated with any particular organization, the users 308a-m are also associated with one or more organizations serviced by the group service provider 302. The users 308a-m and the users of the machines of the organizations 306a-n can receive or send invitations to participate in groups and participate in communications related to tasks associated with the groups. Any of the users 308a-n and the users of the machines of organizations 306a-n can have a role of a group administrator. In some embodiments, each of the machines of the group service provider 302, the organizations 306a-n, and the users 308a-m include a processor system having one or more processors and a memory system storing machine instructions implemented by the processor system. In some embodiments, the machine instructions include the method 100 and an associated user interface for managing groups. In some embodiments, the database 146 is located at the group service provider 302. In some embodiments, the database 146 and the method 100 are run in the network 304 (as cloud services provided by the group service provide 302).

FIGS. 4-14 illustrate screenshots of a user interface for managing groups. Some of the screenshots include features that implement modules corresponding to those of the method 100, but in a different sequence than indicated in the method 100. In general, the fields and the columns (that label the information in the user interface of FIGS. 4-14) correspond to attributes in one or more of the tables of the database 146.

FIG. 5 illustrates information displayed in accordance with one embodiment of the disclosed method and apparatus for managing groups. A display page 500 includes an executive management link 502, group links 504, subgroup links 506, a stakeholder wheel 508, links for organizations 512, filters 514, a bulletin board 516, an organization information link 518, a remove tab link 520 (i.e., for removing organizations). In addition, a generate report link 522, a shared-links link 524, a message board link 526, a recent-items-link 528, a group user link 530 and an integrations link 532 are displayed along a bottom border. In some embodiments, the group users link 530 and the integrations link 532 are only displayed for administrators, since these are administration functions.

Selecting the generate report link 522, the shared-links link 524, the message board link 526, the recent-items-link 528, the group user link 530 and the integrations link 532 implements the modules 132, 134, 138, 140, 136 and 142, respectively.

The page 500 corresponds to the page that is accessed when the group view links 408a and b are selected. In some embodiments, when the page 500 is initially opened, no icons are present. However, a field appears for entering a group name. In some embodiments, after entering the group name, an executive management link 502 and a stakeholder wheel appear.

In some embodiments, when one selects the executive management link 502, a group link 504 appears. In some embodiments, selecting the group link 504 causes a subgroup link 506 (which corresponds to the Subgroup Module 114) to appear and a stakeholder wheel 508 to appear. Selecting the subgroup links 506 allows the user to edit and view information about the subgroups. In some embodiments, the stakeholder wheel 508 includes a second copy of the icon from the group link 504. The stakeholder wheel 508 includes links for organizations 512 attached to the group link 504 by lines emanating from the subgroup link 504, similar to spokes from a wheel. The links for the organizations 512 represent organizations (or stakeholders) that participate in the group associated with the group link 504. When the stakeholder wheel 508 appears, links for filters 514 also appear. In some embodiments, the icons representing the links of the organizations 512 and the filters 514 have corresponding or the same image and colors. The images on the icons of links for the organizations 512 represent the types of organizations. In some embodiments, selecting one of the filters 514 causes the organizations that are not of the type selected to disappear, so that only the organizations of the type selected appear (if there are any organizations of that type). In some embodiments, filters 514 rely on category table 222 for filtering the organizations. In some embodiments, hovering over the group link 504 of the stakeholder wheel 508 causes information about the group to be displayed.

In some embodiment, the bulletin board 516 appears when the executive management link 502 is selected and when the group link 504 appears. The bulletin board 516 includes messages posted by others. The bulletin board 516 includes tools for editing the message on the bulletin board 516 and for writing new messages. In some embodiments, hovering over or selecting the group link 504 of the stakeholder wheel 508 causes the links for managing the groups to be displayed along a border of the page 500 (see the links along the border of FIG. 5 an example, which is discussed below). In some embodiments, hovering over the links for the organizations 512 causes information about the organization (an organization information link 518) to be displayed, taken from organization table 218. In some embodiments, in addition to the information about the organization, one or more links for editing the organization information are displayed, which includes a remove organization link 520.

The screenshot 500 also includes a generate report link 522, a shared-links link 524, a message board link 526, a recent-items-link 528, a group user link 530 and an integrations link 532 along a bottom border.

Selecting the generate report link 522, the shared-links link 524, the message board link 526, the recent-items-link 528, the group user link 530 and the integrations link 532 implements the modules 132, 134, 138, 140, 136 and 142, respectively.

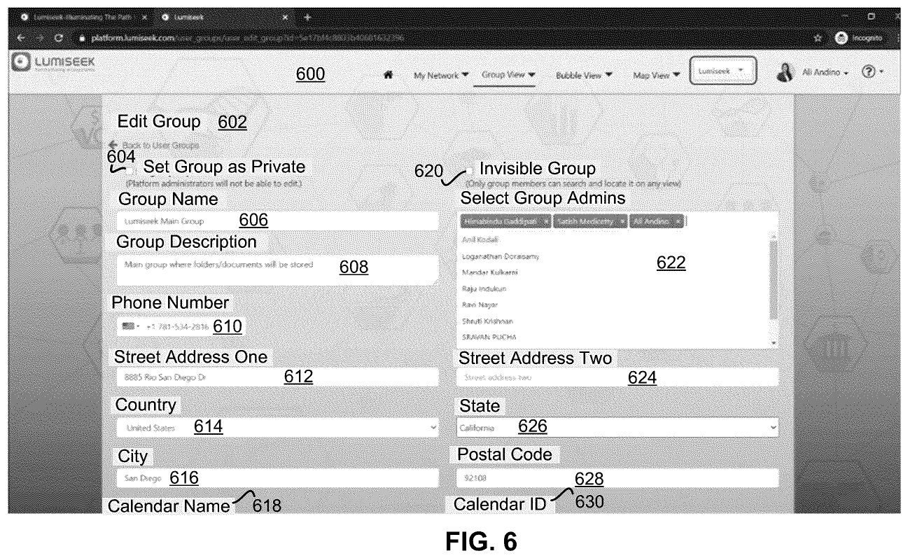

FIG. 6 illustrates a screenshot of a page 602 for creating and editing a group, which includes a set-group-as-private field 604, a group name field 606, a group description field 608, a phone number field 610, a first street address field 612, a country field 614, a city field 616, a calendar name field 618, an invisible group field 620, a select group admins field 622, a second street address field 624, a state field 626, a postal code field 628 and a calendar ID field 630.

The information collected in the page 602 is stored in the group table 206. The set-group-as-private field 604, when selected, keeps the group private so that only members of the group can view the presence of the group and information about the group. The group name field 606 is used for entering or editing the name of the group. The group description field 608 is used for setting and editing the description of the group. The phone number field 610 is used for entering and editing a phone number. The first street address field 612 is used for entering a first street address (“street address one”) associated with the group. The country field 614 is used for entering and editing the country associated with the first address of the group. The city field 616 is used for entering and editing the city associated with the first address of the group. The calendar name field 618 is used for editing and entering a name for identifying a calendar having events associated with the group. In some embodiments, the page 602 includes links and fields for creating and labeling more than one calendar, each having different purposes. The invisible group 620 is a field for selecting whether nonmembers can see that the group exists.

The select group admins field 622 includes links for selecting which users will serve as a group administrator for the group. In some embodiments, each group has only one group administrator. In other embodiments, there may be multiple group administrators associated with one group. In yet other embodiments, the number of group administrators may be controlled by a system administrator (e.g., a person having security credentials that enable that person to make system level changes, such as defining the number of group administrators that can be associated with each group). In some such embodiments, the number of group administrators that can be assigned to a group can be different for each group. In some embodiments, only group administrators (and in some embodiments, system administrators) have the authority to edit information that defines the group. For example, in some embodiments, only group administrators (and in some embodiments, system administrators) can edit the mission statement through the Mission Statement Module 122, edit the description of the group and change the address and phone number of the group. In some embodiments, only the group administrators (and in some embodiments, system administrators) can invite new members to the group and accept requests to join the group. In some embodiments, only group administrators (and in some embodiments, system administrators) can set the agenda of the group and the tasks of the group. In some embodiments, the administrator is given options to acknowledge a response to an invitation for an organization to join a group, remove the invitation from a queue of unanswered invitations and add the organization to the group if the invitation was accepted. The Group Users Module 136 presents the user with options for reviewing the status of invitations to organizations.

A second street address field 624 (“street address two”) is a second street address for the group. The state field 626 is a state associated with the second address of the group, and the postal code field 628 is used for entering and editing the postal code of the second address of the organization. The calendar field 630 includes information about the calendar by which the calendar can be identified.

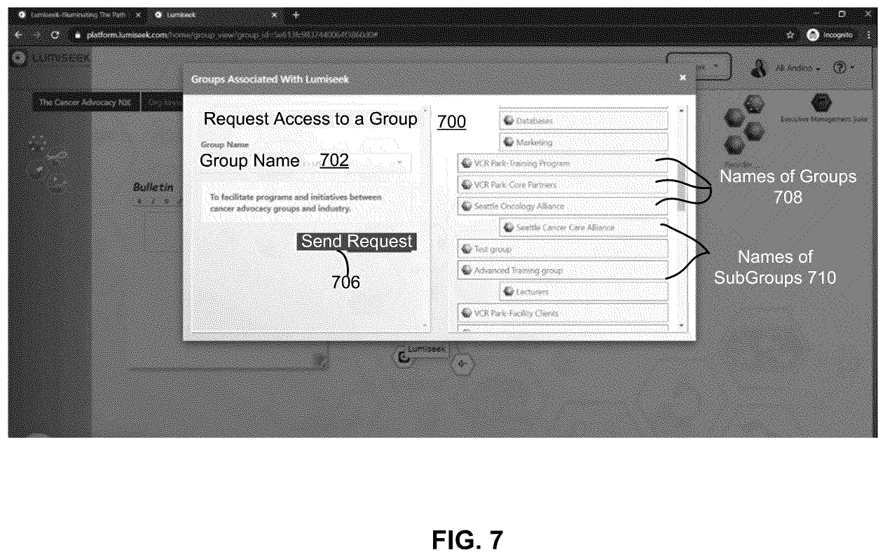

FIG. 7 illustrates a screenshot of a page 700 for viewing groups related to a current group and for requesting entry to the groups related to the current group. The page 700 includes a group name 702, a send request link 706, a names-of-groups tab 708 and a subgroups tab 710.

The group name 702 is a field into which the requester enters the name of the group or subgroup that the requester would like to join. The send request link 706 is a link, which when selected causes a request to be sent to join the group. The names-of-groups tab 708 lists names of groups. In some embodiments, the names-of-groups tab 708 provides information about the group (i.e., a group description). In some embodiments, selecting the names of groups tab 708 provides the user with the mission statement of the group (see module 118). The subgroups tab 710 lists names of subgroups within a group. Selecting the subgroups tab 710 provides information to the user about a subgroup if the user has the authority to view the description of the subgroup.

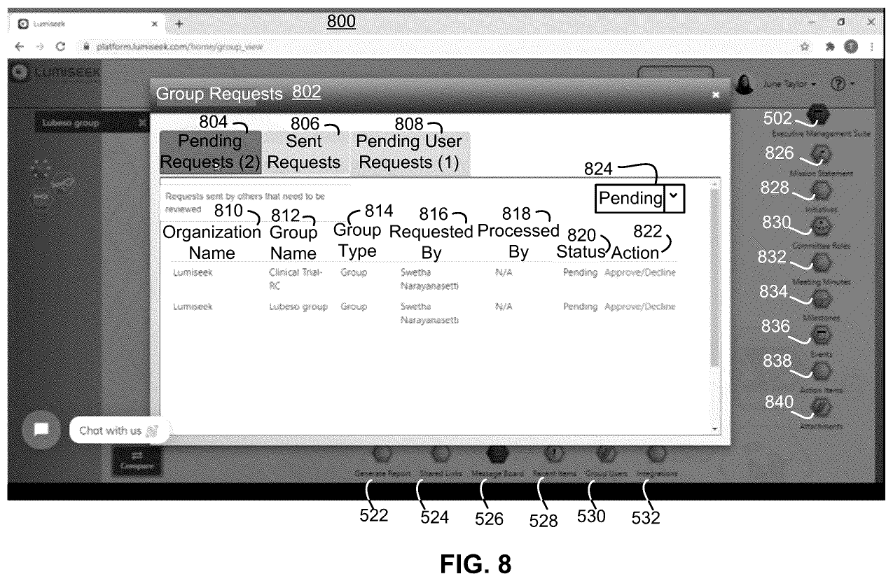

FIG. 8 illustrates a screenshot 800 for a page for managing group requests 802. The page for managing group requests 802 includes a pending requests tab 804, a sent requests tab 806 and a pending user request tab 808.

The pending requests tab 804, when selected, displays a list of requests sent by organizations that have been received to join the group, and that still need to be reviewed. The sent requests tab 806, when selected, lists request that were sent by the group.

The pending user requests tab 808, when selected, lists requests to join the group sent by individual users that need to be reviewed. In the screenshot 800, the pending requests tab 804 is selected. The information listed includes an organization name column 810, a group name column 812, a group type column 814, requested by column 816, a processed by column 818, a status column 820 and an action column 822.

The screenshot 800 also includes a filter 824, a mission statement link 826, an initiative link 828, a committee role link 830, a meeting minutes link 832, a milestones link 834, an events link 836, an action items link 838 and an attachments link 840 along a side border. Each of the links 826, 828, 830, 832, 834, 836, 838, 840 are displayed when the executive management link 502 is pressed and are active only when no other window is open over the window in which these links are displayed. For example, in FIG. 8, a group requests page 802 is open, which results in the links 826, 828, 830, 832, 834, 836, 838, 840 being displayed in a subdued format (i.e., greyed) and making the links 826, 828, 830, 832, 834, 836, 838, 840 inactive until the group request page 802 is closed.

The organization name column 810 includes names of the organizations making the request, the group name 812 includes the name of the group to which access is requested and the group type column 814 specifies the type of the group named in the group name column 812. The requested by column 816 lists the name of the one making the request, the reviewed by request lists the user assigned to review the request, and the status column 820 lists the status of the request (pending, refused or accepted). When the sent requests tab 806 and the pending user request tab 808 are selected, similar types of columns appear with information relevant to that tab.

Selecting the mission statement link 826, the initiatives link 828, the committee roles link 830, the meeting minutes link 832, the milestones link 834, the events link 836, the action items link 838 and the attachments link 840 implements module 118, 120, 122, 124, 126, 128 and 130, respectively.

The mission statement link 826, the initiative link 828, the committee role link 830, the meeting minutes link 832, the milestones link 834, the events link 836, the action items link 838 and the attachments link 840 appear when the user selects the group link 504 or the executive management link 502, depending on the mode or embodiment. In the embodiments, of FIG. 8, the mission statement link 826, the initiative link 828, the committee role link 830, the meeting minutes link 832, the milestones link 834, the events link 836, the action items link 838 and the attachments link 840 are icons that are displayed at the margin of the page for accessing these functions.

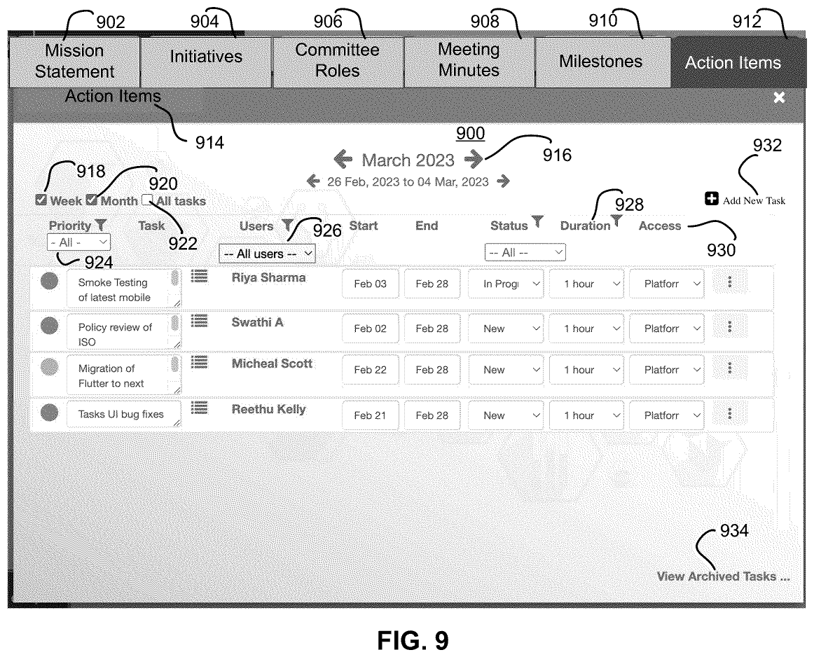

FIG. 9 illustrates a screenshot of a page 900. Page 900 includes a mission statement tab 902, an initiatives tab 904, a committee roles tab 906, meeting minutes tab 908, milestones tab 910, action items tab 912 and action box 914. Action box 914 includes a filter selection 916, an all filter 918, a new filter 920, an in-progress filter 922 and a completed filter 924.

Selecting the mission statement tab 902, the initiatives tab 904, the committee roles tab 906, the meeting minutes tab 908, the milestones tab 910 and the action items tab 912 provides a page having fields and links for implementing the modules 118, 120, 122, 124, 126 and 128, respectively.

FIG. 9 illustrates a screenshot of a page 900. The page 900 includes a mission statement tab 902, an initiatives tab 904, a committee roles tab 906, meeting minutes tab 908, milestones tab 910, action items tab 912 and action box 914. Action box 914 includes a date selection field 916, a week field 918, a month field 920, an All field 922, a priority filter 924, a user filter 926, a status filter 928, a duration filter 930, an add new task link 932 and a view archived tasks link 934.

Selecting the mission statement tab 902, the initiatives tab 904, the committee roles tab 906, the meeting minutes tab 908, the milestones tab 910 and the action items tab 912 activates the modules 122-128, respectively, and provides pages having fields and links for interacting with the modules activated.

In FIG. 9, the action item tab 912 is selected, causing the action item box 914 to be displayed. The action item box 914 includes a list of tasks/action items (see module 128). In some embodiments, the list includes a priority column, a start column, an end column, a description column and a user column displaying the priority of the task, the date that the action item was assigned, the date when the action items should be completed, a description of the task and an identifier (i.e., a username) of a user assigned to the task. The action items box 914 also includes links for updating the tasks, indicating progress, additions or removal of users assigned to the task and changes to the deadline and the task.

The week field 918 and the month field 920, when selected cause each page of tasks to include the tasks scheduled to end during a given week and month, respectively. In the example of FIG. 9, since both the week and month fields are selected, the tasks displayed are due in January, during the week of Feb. 26, 2023, to Mar. 4, 2023. The All field 922 causes all of tasks of all dates to be displayed. The priority filter 924, the user filter 926, the status filter 928 and the duration filter 930 filter tasks based on their priority, the particular user to whom the task is assigned, the status of the task and the duration of the task, respectively. In some embodiments, the priority filter 924, the user filter 926, the status filter 928 and the duration filter 930 are each related to (and in some embodiments located above) a column displaying a value for the priority, the user, the status and the duration of the task, respectively. In some embodiments, the priority of the task (e.g., high, medium, and low) is indicated by a color dot displayed near the task (i.e., the priority column). In some embodiments, the row having the task is color-coded according to the priority of the task. Some examples of values that the status of a task can assume include new, in-progress and completed. In the example of FIG. 9, the priority filter 924, the user filter 926, the status filter 928 and the duration filter 930 are each set to ALL, causing all tasks to be displayed.

The add new task link 932, when selected, adds a new task to the list of tasks and presents editable fields to the user, via which values characterizing the task can be entered (i.e., fields for entering a description, a priority, a duration and a user to whom the task is assigned). View archived tasks 932, when selected, causes archived tasks to be displayed. When the view archived tasks link 934 is selected tasks that have been archived also appear in the list of tasks.

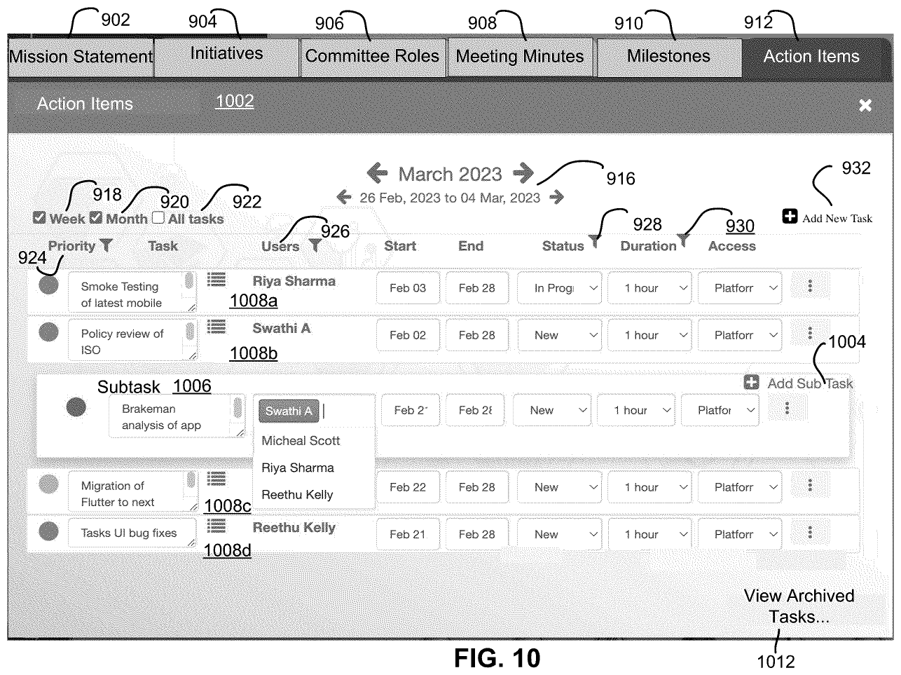

FIG. 10 illustrates a screenshot of an example of an action item box 1002 and the page 900. In the example of FIG. 10, the action items box 1002 (in addition to the elements shown in FIG. 9) includes an add subtasks link 1004, subtasks 1006 and tasks 1008a-d. In some embodiments of the task box 1002, icons (i.e., color-coded icons) are included to indicate the priority of the tasks. The action item box 1002 is the portion of the page 900, in FIG. 10, below the tabs. Action items box 1002 is labeled differently than in FIG. 9, only to reflect that it is a different page than illustrated in FIG. 10, since in FIG. 9, the subtask has not been added yet.

The add subtasks link 1004, when selected, causes a subtask to be added to a task. In some embodiments, an add subtask link is associated with each task. In some embodiments, when the add subtask link 1004 is selected, fields are displayed into which information characterizing the subtask can be entered. In some embodiments, the same types of information that characterize a task characterize a subtask (i.e., a description, a priority, a status and a duration). Subtask 1006 is an example of information that is displayed to characterize a subtask and tasks 1008a-d are examples of information that are displayed to characterize a task. In the example of FIG. 10, subtask 1006 is a subtask of task 1008b. In some embodiments, subtasks are presented in a manner that is visually distinct from tasks. In some embodiments, the row of a subtask is indented under the row of the task to which the subtask is related. In the example of FIG. 10, the field for assigning a user to a task is a pulldown menu, which is illustrated as still being open. Using a pulldown menu instead of allowing receipt of a text entry helps ensure that the users assigned to the task have joined the group and are authorized for performing the task.

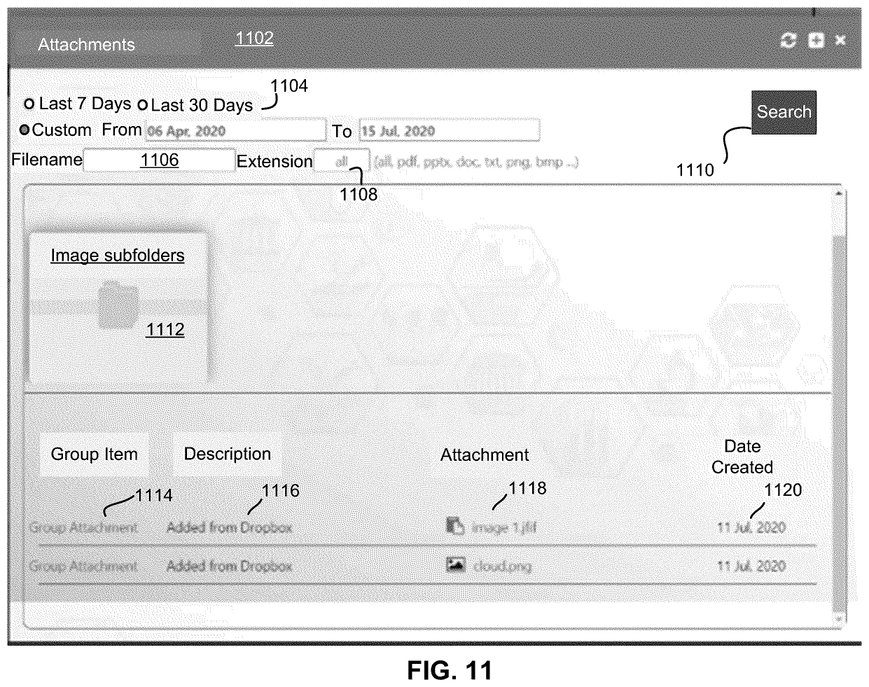

FIG. 11 illustrates a screenshot of an attachment page 1102, which lists shared documents. Attachment page 1102 is related to module 132. The attachments page 1102 includes a date range 1104 for indicating the date range of the attachments of interest. A filename field 1106 is a field for entering a filename of a file of interest. An extension field 1108 is for choosing the type of file (.pdf, .docx, .rft or .png, for example). A search link 1110, when selected, causes a search to be conducted for the file identified by the filename field 1106 and the file type field 1108. An image subfolder 1112 is an icon representing a subfolder containing some of the documents that are shared by the group. In some embodiments, the list includes a group item column 1114, a description item 1116, an attachment column 1118, and a date-created column 1120. The group item column 1114 identifies a type of group item (i.e., attachment). The description item column 1116 indicates a description of the attachments, such as where the attachments originated from (i.e., from Dropbox). The attachment column 1118 lists names of the files having the attachments. The date created column 1120 lists the date at which the attachment was created.

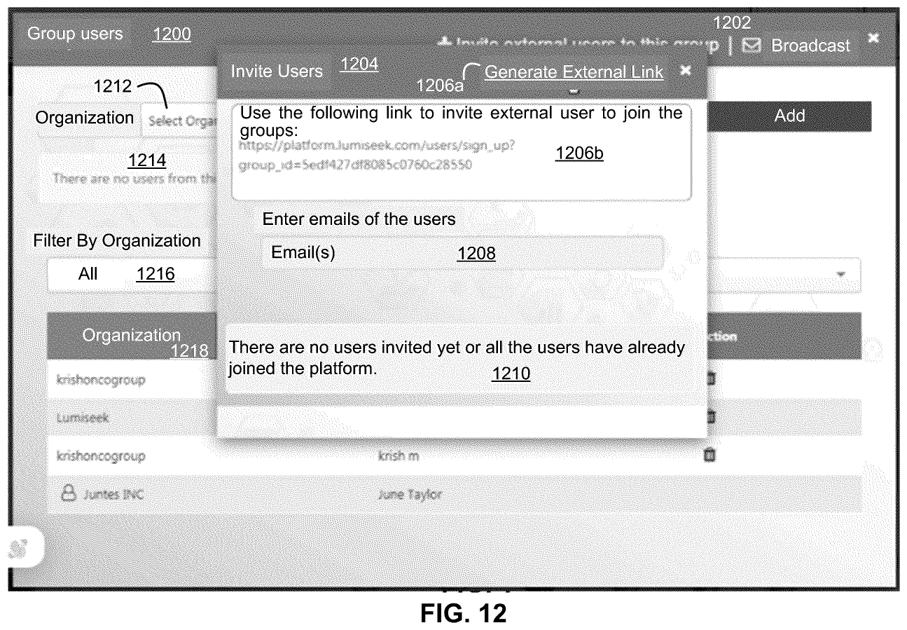

FIG. 12 illustrates a screenshot of a group-users page 1200, displaying a view 1202 having an invite-user box 1204. The invite-user box 1204 is for inviting users to join the group. The invite-user box 1204 is related to invite user table 224. A generate-external-link 1206a is for generating a URL of a link to a form for joining a group. A field 1206b is for displaying the URL created by generate-external-link 1206a. An email field 1208 is for entering the email address of the user. A list 1210 lists other users that have been invited to the group. An organization field 1212 is used for entering the organization associated with the user. A list of users 1214 lists other users. A filter by organization 1216 is for filtering which organizations appear in a list of organizations 1218. The list of organizations 1218 includes a column for the name of the organization, a user column for listing the name of the user associated with the organization and an action column, including one or more icons for taking actions (i.e., editing the user information, which in an embodiment includes removing the user).

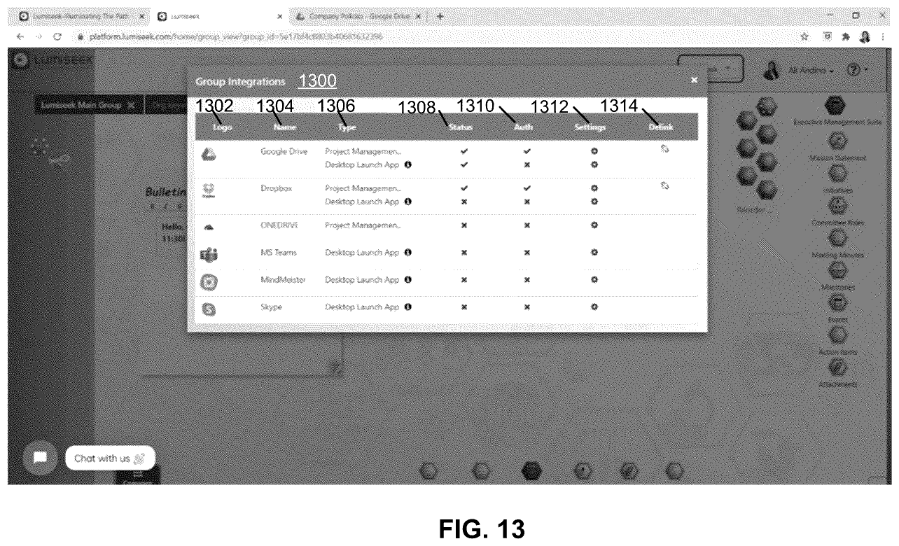

FIG. 13 illustrates a screenshot of a group integration page 1300. The group integration page 1300 is for integrating third-party applications and platforms into the group system. The group integration page 1300 is related to module 142. The group integration page 1300 includes a list of integrated applications and platforms already integrated into the system 300. The embodiment of FIG. 13, the group integration page 1300 includes a logo column 1302, a name column 1304, a type-column 1306, a status column 1308, a settings column 1310 and a delink column 1312. The logo column 1302, the name column 1304, the type-column 1306 and the status column 1308 list the logo, name, type, status and the authorization of the application or platform, respectively. The authorization column 1310 indicates whether the user is authorized to use the application or the platform. A settings column 1312 includes a link, which when selected, provides a box or page for choosing settings for the integrated application. A delink column 1314 provides an indication of whether the application is delinked and an option to delink linked applications.

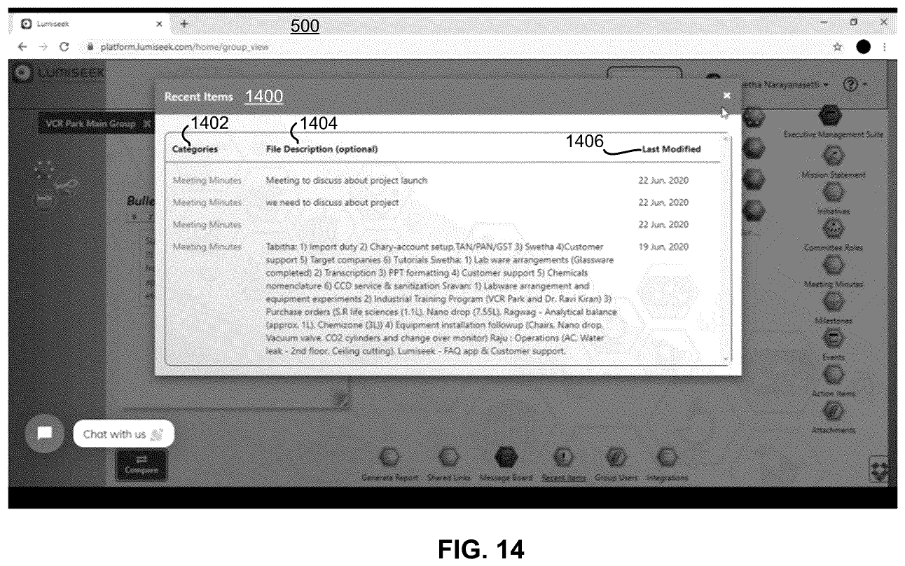

FIG. 14 illustrates a page of recent items 1400. The page of recent items 1400 is related to module 142. The page of recent items 1400 includes a categories column 1402, a file description column 1404 and a last modified column 1406. The categories column 1402 lists the category of the recent item (e.g., meeting minutes, action items and group invitations). The file description column 1404 includes a description of the item. The last modified column 1406 lists the last date on which the item was modified.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in the discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An organization network management system comprising:
a. a memory device (MD) having a first MD input, a first MD output, a MD second output;
b. a User Input Receiving Module (UIRM) having a first UIRM input and a first UIRM output, the first UIRM input being configured to received user input from a user input device;
c. a System Administration Module (SAM) having a first SAM input, a second SAM input, a third SAM input, a first SAM output, a second SAM output, and a third SAM output, the first SAM input coupled to the first UIRM output, the second SAM input coupled to the first MD output, and the first SAM output coupled to the first MD input;
d. a Display Control Module (DCM) having a first DCM input coupled to the second SAM output and having a first DCM output configured to be coupled to a display device, the DCM providing information through the first DCM output to be used by the display device to display a homepage having a plurality of icons, including a bubble view icon;
e. a Graphical Dashboard Module (GDM) comprising a Group Hexagon Diagram Module (GHDM) having a first GHDM input and first GHDM output, the first GHDM input coupled to the third SAM output and a first GHDM output coupled to the third SAM input, the GDM configured to access group information through the SAM, configure the group information for display, and provide the group information to the SAM for display on the display device under control of the DCM.

2. The organization network management system of claim 1, further comprising a CRUD (Create, Read, Update and Delete) Module having a first CRUD input and a first CRUD output, wherein the first SAM output is coupled to the first MD input via the CRUD, such that the first SAM output is coupled to the first CRUD input and the first CRUD output is coupled to the first MD input.

3. An organization network management system comprising:
a) a processor system having one or more processors and
b) a memory system including a non transient machine-readable media storing one or more machine instructions, which, when implemented by the processor system, causes the processor system to present to a user:
i) a visual indication of a group;
ii) visual indications of organizations that are part of the group, and the organizations are interconnected to one another within the group; and
iii) tools for managing the group by a group administrator, the group administrator being associated with one of the organizations,
therein facilitating collaboration between the organizations.

4. The organization network management system of claim 3, the tools being to establish a hierarchy based on objectives of the group; the organizations having hierarchical structures that are independent of the hierarchy that is based on the objectives of the group.

5. The organization network management system of claim 3, wherein the processor system further presents to the user a visual indication of subgroups within the group.

6. The organization network management system of claim 3, the tools including a tool for establishing a communication with an organization.

7. The organization network management system of claim 3, wherein the processor system further presents to the user, user visual indications of filters, which, when selected, determine which of the visual indications of the organizations are presented to the user.

8. The organization network management system of claim 7, wherein, when one of the filters is selected, the visual indications of the organizations that are presented are determined based on a category associated with the organizations selected.

9. The organization network management system of claim 3, wherein the processor system:
a) receives input related to a location on a display associated with a visual indication of an entity; and
b) in response, presents to the user, information about the entity.

10. The organization network management system of claim 3, the organizations having indications of categories associated with the organizations.

11. The organization network management system of claim 3, wherein the processor system further presents to the user:
a) a visual object, which, when selected, opens user-chosen links to third-party platforms.

12. The organization network management system of claim 3, wherein the processor system further presents to the user, a tool, which when selected presents to the user a page for assigning tasks to other users.

13. The organization network management system of claim 3, wherein the processor system further presents to the user a tool, which when selected presents to the user a page indicating a status of a task.

14. The organization network management system of claim 3, wherein the processor system further presents to the user a tool, which when selected presents to the user a page for creating groups.

15. The organization network management system of claim 14, wherein the page provides the user with interfaces to create groups, including a field for creating milestones for the group.

16. The organization network management system of claim 14, wherein the page includes a field for setting objectives, milestones, and a mission statement for the group.

17. The organization network management system of claim 14, wherein the page includes a field for choosing administrators, wherein the administrators have authority to alter the group.

18. The organization network management system of claim 14, wherein the page includes a field for selecting whether the group is visible to nonmembers of the group.

19. The organization network management system of claim 3, wherein the processor system further presents to the user a tool, which, when selected, presents to the user a bulletin board that is visible to the group and is editable by the group administrator, the bulletin board being for posting information of interest to the group.

20. The organization network management system of claim 3, wherein the processor system further presents to the group administrator a tool, which when selected presents to the user, a page for viewing groups to which the group administrator is an administrator.

21. The organization network management system of claim 3, the method for comprising presenting to the user a tool, which, when selected, presents to the user links to documents associated with the group.

22. The organization network management system of claim 3, the method for comprising:
a) receiving input indicating a change to a calendar event; and
b) in response, automatically sending, by the processor system, to a third-party-calendar-system information, which, when received, causes the third-party-calendar-system to alter calendar information reflecting the change to the calendar event.
